(19) United States
(12) Patent Application Publication
(10) Pub. No.: US 2010/0161893 A1
(43) Pub. Date: Jun. 24, 2010

(54) DISK SYSTEM USING MEMORY CONTROL SIGNAL OF PROCESSOR

(76) Inventor: Seung Kook Cheong, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/641,220

(22) Filed: Dec. 17, 2009

(30) Foreign Application Priority Data
Dec. 19, 2008 (KR) 10-2008-0130710

(51) Int. Cl. G06F 12/00; H02J 9/00

(52) U.S. Cl. 711/104; 307/66; 711/E12.001

(57) ABSTRACT

The disk system of the present invention decreases defects of a volume restriction and a volatile characteristic of a RAM disk using a memory control signal of a host. The preset invention provides a disk system including a central control unit generating a memory control signal corresponding to a RAM memory and an external instruction and controlling the RAM memory, and wherein the RAM memory including a RAM disk constituted by RAMs and storing a system program and data; and a control signal processing unit converting the memory control signal into first and second memory control signals based on access information included in the memory control signal and controlling the RAM disk to access to the system program and the data by the second memory control signal.

### BACKGROUND OF THE INVENTION

(a) Field of the Invention

The present invention relates to a disk system. More particularly, the present invention relates to a disk system decreasing defects of a volume restriction and a volatile characteristic of a RAM (Random Access Memory) disk by using a memory control signal of a host.

(b) Description of the Related Art

In general, a memory connected to a processor has been used for processing data and a portion of the memory has been used as a RAM disk for improving a speed of a program. In using the RAM disk, a fast data process is possible by the maximum using of a memory bandwidth. However, a volume is restricted because a portion of the system memory is dynamically allocated and then used and a data loss is occurred when a system suddenly and abnormally works.

A hard disk has various advantages that a volume restriction of a hard disk is almost not occurred, and the data storing is possible until the abnormal work is occurred in the system and a cost is low. However, the hard disk has a slow operation speed and is weak to the vibration due to an attribute of a disk which mechanically controls a rotating magnetic disk.

For decreasing the defects of the hard disk, a solid state drive (SSD) which decreases power consumption, generation of heat, noise generation, a weight, and a size etc. in spite of a fast data processing speed has been manufactured. However, the solid state drives has performance deteriorations such as a high cost and a lower speed than that of the hard disk in continuous read and write operations, not in accessing to the data.

### SUMMARY OF THE INVENTION

The present invention has been made in an effort to provide a disk system decreasing defects of a volume restriction and a volatile characteristic, dissolving problems such as a slow data processing speed and high power consumption, and a noise etc., and improving performances in a data access speed and continuous read and write operations.

According to an aspect of the present invention, a disk system includes a central control unit generating a memory control signal corresponding to a RAM memory and an external instruction and controlling the RAM memory, and wherein the RAM memory includes a RAM disk constituted by RAMs and storing a system program and data; and a control signal processing unit converting the memory control signal into first and second memory control signals based on access information included in the memory control signal and controlling the RAM disk to access to the system program and the data by the second memory control signal.

The disk system of the present invention stores a system program and data using a RAM disk having a volatile RAM, based on a memory control signal having a largest bandwidth of external signals of a host, and thereby a high speed RAM disk substitutes for r a hard disk of a related.

In addition, the disk system of the present invention, by using the RAM disk, realizes a light weight, a low noise, low power consumption, and a high performance, is applied to a storage server and a file server requiring a large volume, and has an advantage of easier maintenance and repair operations.

### BRIEF DESCRIPTION OF THE DRAWINGS

FIG. 1 is a schematic diagram showing a disk system according to an exemplary embodiment of the present invention;

FIG. 2 is a functional block showing an example of the control signal processing unit shown in FIG. 1;

FIG. 3 shows a memory map for the indirect address access of FIG. 2;

FIG. 4 shows an example of the memory map of FIG. 3;

FIG. 5 is a functional block representing elements of the RAM memory in FIG. 2; and

FIG. 6 shows a hierarchy structure according to functions showing a driving structure of a disk system according to an exemplary embodiment of the present invention.

### DETAILED DESCRIPTION OF THE EMBODIMENTS

A disk system according to an exemplary embodiment of the present invention will be described with reference to accompanying drawings.

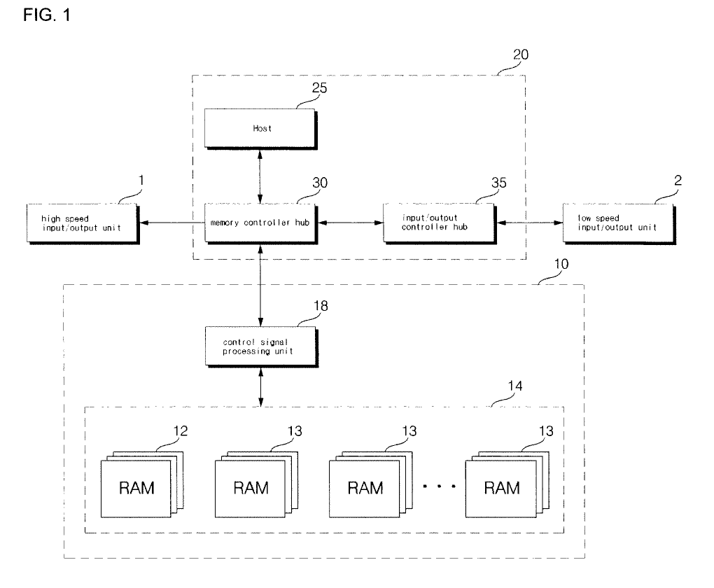

FIG. 1 is a schematic diagram showing a disk system according to an exemplary embodiment of the present invention.

Referring to FIG. 1, a disk system according to an exemplary embodiment of the present invention includes a RAM memory 10 and a central control unit 20 generating a memory control signal for controlling the RMA memory 10. The memory control signal corresponds to an external instruction.

Here, the central control unit 20 controls the disk system. The central control unit 20 includes a host 25, a memory controller hub 30, and an input/output controller hub 35. The host 25 generates the memory control signal for controlling the RAM memory 10. The memory controller hub 30 supplies a FSB (front side bus) interface to the host 25, transmits the memory control signal transmitted from the host 25 to the RAM memory 10, and is connected to a high speed input/output unit 1. The input/output controller hub 35 is connected to a low speed input/output unit 2 and is supplied an interface with respect to the low speed input/output unit 2 from the memory controller hub 30.

The memory controller hub 30 is connected to an interface for the high speed input/output unit 1, an interface for the input/output controller hub 35, and the RAM memory 10 by a PCI express port.

Here, the memory controller hub 30 receives the memory control signal through the host 25 and the FSB interface to transmit to RAM memory 10.

The FSB interface denotes all buses used when the host 25 transmits instructions and data for operations to the RAM memory 10.

The input/output controller hub 35 supplies connection ports for the low speed input/output unit 2 such as an USB 2.0, an Ultra ATA 100, a SATA, a flash BIOS, a PCI, a AC97, or a LAN, etc. and connects to the connection ports.

The RAM memory 10 is a volatile RMA. In this embodiment, an example of the RAM memory 10 is a DRAM (dynamic RAM).

That is, the RAM memory 10 is constituted by RAMs and includes a RAM disk 14 and a control signal processing unit 18. The RAM disk 14 stores a system program and data. The control signal processing unit 18 converts the memory control signal into first and second memory control signals, based on access information included in the memory control signal transmitted from the memory controller hub 30 of the central control unit 20 and controls the RAM disk 14.

Here, the RAM disk 14 includes a system memory 12 in which the system program is stored and disk memories 13 storing the data.

The system memory 12 directly accesses to an address through the host 25 and a first channel to access to the system program, and the disk memories 13 indirectly access to addresses through the host 2 and second to N channels, to store the data or access to the data.

Here, each of the disk memories 13 includes a plurality of RAMs.

The control signal processing unit 18 interprets the access information included in the memory control signal transmitted from the memory controller hub 30 and determines whether the host 25 directly address-accesses or indirectly address-accesses to the RAM disk 14, to thereby transmit the first and second memory control signals to the RAM disk 14.

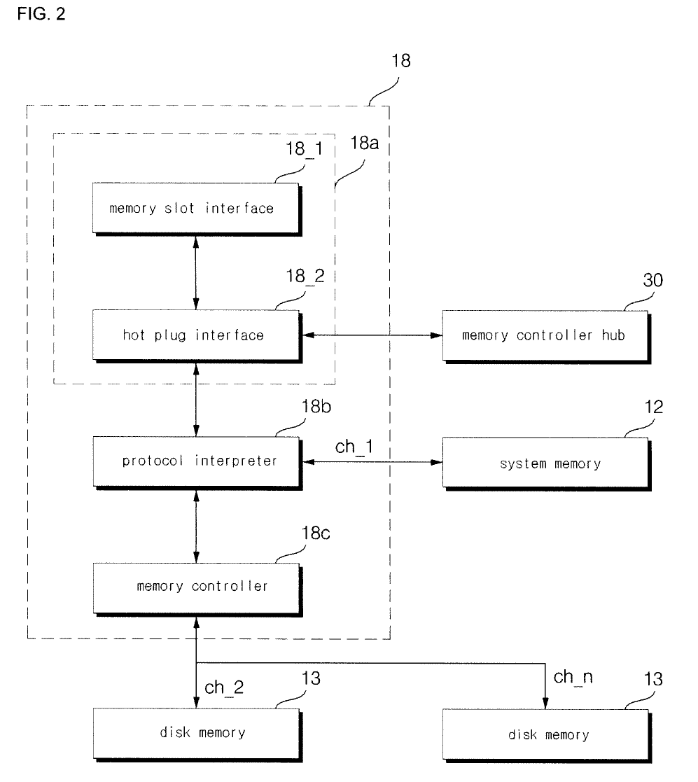

FIG. 2 is a functional block showing an example of the control signal processing unit shown in FIG. 1.

As shown in FIG. 2, the control signal processing unit 18 includes an interface expansion unit 18a, a protocol interpreter 18b, and a memory controller 18c. The interface expansion unit 18a supplies an interface when an external memory and an RAM are added and is supplied with the memory control signal from the memory controller hub 30. The protocol interpreter 18b receives the memory control signal to interpret the access information. Thereby, when the interpretation result is a direct address access, the protocol interpreter 18b converts the memory control signal into the first memory control signal and controls to transmit the converted first memory control signal to the system memory 12 through the first channel ch_1. On the contrary, when the interpretation result is an indirect address access, the protocol interpreter 18b generates channel information with respect to the second to N channels ch_2 to ch_n. The memory controller 18c controls the disk memories 13 allocated to the second to N channels ch_2 to ch_n, based on the channel information.

Here, the access information includes direct address access information and indirect address access information. By using the direct address access information, the host 25 directly accesses to store addresses of the system program allocated to the system memory 12 depending on each address through the first channel ch_1 by the protocol interpreter 18b. By using the indirect address access information, the host 25 indirectly accesses to store addresses of the data allocated to the disk memories 13 depending on each address through the second to N channels ch_2 to ch_n by the protocol interpreter 18b.

The interface expansion unit 18a includes a memory slot interface 18_1 and a hot plug interface 18_2. The memory slot interface 18_1 include a slot at which the external memory is installed, and the hot plug interface 18_2 is capable of installing an additional RAM and is supplied with the memory control signal from the host 25.

Thereby, when the system is operated, the additional RAM disk 10 is installed by virtue of the hot plug interface 18_2.

The memory controller 18c transmits the second memory control signal to one disk memory 13 of the disk memories 13 allocated to the second to N channels ch_2 to ch_n using the channel information, which indirectly accesses to the host 25.

At this time, for the indirect address access, the memory controller 18c transmits the second memory signal to the disk memories 13, that is, the RAMs constituting the disk memories 13 to control the RAMs, using a command cmd, an address, and a register (not shown) temporally storing a value corresponding to the data in a memory map.

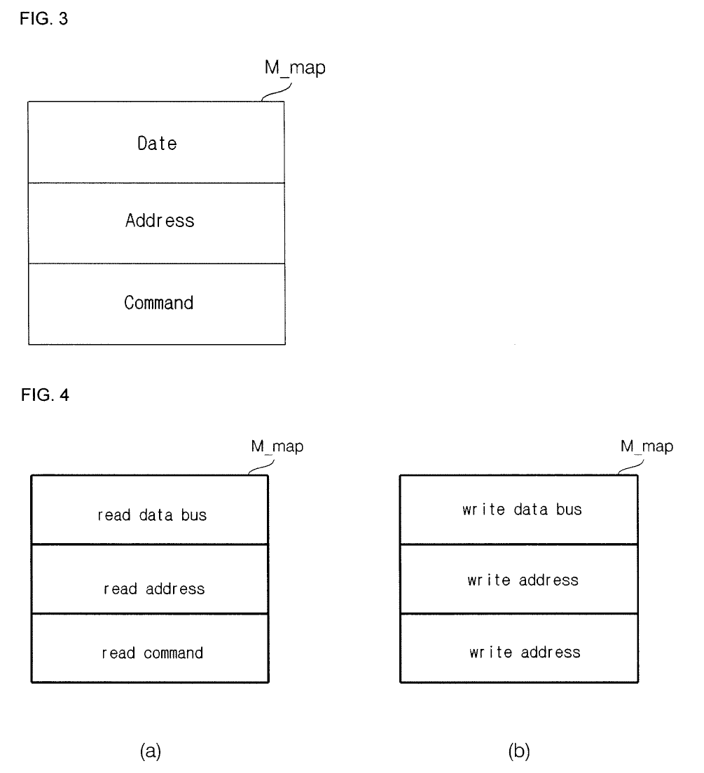

FIG. 3 shows a memory map for the indirect address access of FIG. 2 and FIG. 4 shows an example of the memory map of FIG. 3.

Referring to FIG. 3, when the host 25 and the disk memory 13 indirectly address-access, the control signal processing unit 18 converts the memory control signal into the second memory control signal and transmits the converted second memory control signal to the disk memories 13, using the command cmd, the address, and the register temporally storing the value corresponding to the data in the memory map M_map.

When the register reads or writes 32bit-data in an address space (2³²=4 Giga) of 32 bits, the control signal processing unit 18 accesses to the disk memory 13 of 4 GB by the second memory control signal using the command, the address, and the register of the 32bit-data.

Thereby, the disk memory 13 using the indirect address access has a response speed faster than a hard disk performing an indirect address access of a related art and is able to expand a volume thereof. In addition, the memory control signal of the host 25 has the largest bandwidth of signals which are transmitted from the host 25 to an external, and thereby a bandwidth of the second memory control signal becomes large to improve an access speed and a processing ability of data.

The memory map M_map is stored into the control signal processing unit 18 as a register including a data buffer (not shown) such that the memory map M_map shown in FIG. 3 is separated into a read pass and a write pass, as shown in FIG. 4.

That is, (a) of FIG. 4 shows a data buffer register with respect to the read pass of the data and the memory map M_map of FIG. 3 is converted into a read data buffer R_data, a read address R_address, and a read command R_cmd. Thereby, since the read pass of the data is separated, a data read speed is improved.

(b) of FIG. 4 shows a data buffer register with respect to the write pass of the data, and the memory map M_map of FIG. 3 is converted into a write data buffer W_data, a write address W_address, and a write command W_cmd. Thereby, since the write pass of the data is separated, a data write speed is improved.

That is, as shown in (a) and (b) of FIG. 4, since the read and write passes of the data are separated from the host 25, the access speed and the processing speed of the data increase.

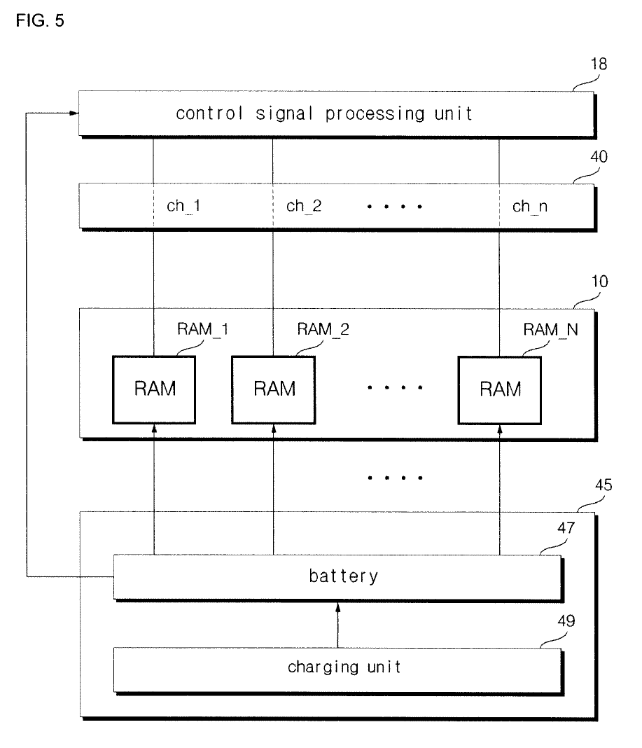

FIG. 5 is a functional block representing elements of the RAM memory in FIG. 2.

Referring to FIG. 5, the RAM memory 10 according to the embodiment includes a plurality of RAMs RAM_1˜RAM_N allocated to the system memory 12 and the disk memories 13, a channel interface 40 including a plurality of channels ch_1 to 1˜ch_n connected to the plurality of RAMs RAM_1˜RAM_N, the control signal processing unit 18 connected to the plurality of RAMs RAM_1˜RAM_N through the plurality of channels ch_1˜ch_n, and an emergency power supply 45 supplying an emergency power source when a driving power source is not applied to the control signal processing unit 18.

That s, the plurality of RAMs RAM_1˜RAM_N are volatile RAMs, and thereby when the driving power source is not applied to the RAMs, data stored into the RAMs are deleted.

The emergency power supply 45 includes a battery 47 supplying the emergency power source and a charging unit 48 charging the emergency power source to the battery 47.

Since the plurality of RAMs RAM_1˜RAM_N are always supplied with the driving power source or the emergency power source, the data are safely stored into the RAMs and addresses of the data are maintained.

The disk memories 13 are separate elements of which addresses are not allocated to the system memory 12.

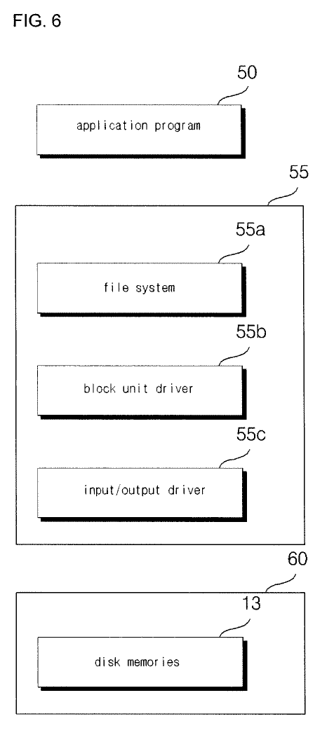

FIG. 6 shows a hierarchy structure according to functions showing a driving structure of a disk system according to an exemplary embodiment of the present invention.

Referring to FIG. 6, the disk system is divided into an application program 50, an operating system 55, and hardware 60.

Here, the operating system 55 includes a file system 55a, a block unit driver 55b supplying API (application programming interface) for the file system 55a, and an input/output driver 55c managing the hardware 60, that is, the disk memories 13.

The number of the block unit driver 55b is one when the hardware 60 is constituted as one disk volume and is N when the hardware 60 is constituted as N disk volumes, and the block unit driver 55b is installed on the system memory 12.

The file system 55a supplies the API for the application program 50, and thereby a user accesses to the disk memories 13.

That is, the disk memories 13 perform a partition setting and a boot setting by the file system 55a and executes the same operations as the hard disk of the prior art.

The disk system according to the present invention stores and processes the data using the volatile RMAs. Thereby, a booting operation of the disk system is possible using the system memory by operating only the RAM memories without the hard disk of the related art and the data are processed through the disk memory at a high speed.

Further, the disk system according to the present invention realizes a light weight, a low noise, low power consumption, and a high performance, and is applied to a storage server and a file server requiring a large volume. In addition, maintenance and repair operations of the disk system are easier than those of the hard disk.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A disk system using memory control signal of processor comprising;
a RAM memory; and
a control unit generating memory control signal corresponding to a external instruction
wherein the RAM memory comprises
a RAM disk which is constituted by RAMs and stores a system program and data; and
a control signal processing unit converting the memory control signal into first and second memory control signals based on access information included in the memory control signal and controlling the RAM disk to access to the system program and the data by the second memory control signal.

2. A disk system using memory control signal of processor of claim 1, wherein the central control unit comprises:
a memory controller hub supplying a FSB (front side bus) interface to the host and transmitting the memory control signal transmitted from the host to the RAM memory; and
an input/output controller hub being supplied with an interface with respect to a low speed input/output unit from the memory controller hub.

3. A disk system using memory control signal of processor of claim 1, wherein the RAM disk comprises a system memory directly accessing to an address through a first channel by the central control unit and accessing to the system program by the first memory control signal; and
a disk memory indirectly accessing to addresses through second to N channels by the central control unit and storing or accessing to the data by the second memory control.

4. A disk system using memory control signal of processor of claim 3, wherein the disk memory is an independent element separated from the system memory.

5. A disk system using memory control signal of processor of claim 3, wherein the control signal processing unit comprises:
an interface expansion unit supplying an interface when an external memory and an RAM are added and being supplied with the memory control signal; and
a protocol interpreter receiving the memory control signal to interpret the access information, converting the memory control signal into the first memory control signal and controlling to transmit the converted first memory control signal to the system memory through the first channel when an interpretation result is a direct address access, and generating channel information with respect to the second to N channels when the interpretation result is an indirect address access.

6. A disk system using memory control signal of processor of claim 5, wherein the memory controller comprises a command, an address, and a register temporally storing a value corresponding to data in a memory map for the indirect address access.

7. A disk system using memory control signal of processor of claim 6, wherein the register is a buffer resister dividing a read pass and a write pass for processing the data.

8. A disk system using memory control signal of processor of claim 1, further comprising an emergency power supply supplying an emergency power source to the RAM disk and the control signal processing unit. A disk system using memory control signal of processor of claim 8, wherein the emergency power supply comprises:
a battery supplying the emergency source; and
a charging unit charging the emergency power source to the battery.
